(19) United States
(12) Patent Application Publication
(10) Pub. No.: US 2015/0192420 A1
(43) Pub. Date: Jul. 9, 2015

(54) FOLLOW-ME APPLICATION

(71) Applicants: Brendan Murphy Watters, Silver Spring, MD (US); Gordon John Hines, Kirkland, MD (US); Drew A. Morin, Davidson, MD (US); Victor Burton, Bellevue, WA (US)

(72) Inventors: Brendan Murphy Watters, Silver Spring, MD (US); Gordon John Hines, Kirkland, MD (US); Drew A. Morin, Davidson, MD (US); Victor Burton, Bellevue, WA (US)

(73) Assignee: TELECOMMUNICATION SYSTEMS, INC., Annapolis, MD (US)

(21) Appl. No.: 14/591,614

(22) Filed: Jan. 7, 2015

Related U.S. Application Data
(60) Provisional application No. 61/925,490, filed on Jan. 9, 2014.

(51) Int. Cl. G01C 21/34

(52) U.S. Cl. CPC G01C 21/34

(57) ABSTRACT

A follow-me application can be configured to generate a follow-me identifier (ID) that uniquely identifies a particular route traveled by a computing device executing the follow-me application. The follow-me application can also be configured to determine route data for the particular route traveled. The route data characterizes turn-by-turn directions to facilitate travel along the particular route by another computing device.

### CROSS-REFERENCE TO RELATED APPLICATION

This application claims the benefit of priority to U.S. Provisional Application No. 61/925,490, filed on Jan. 9, 2014, and entitled FOLLOW-ME APP, the entirety of which is herein incorporated by reference.

### TECHNICAL FIELD

This disclosure relates to a follow-me application that can generate route data characterizing a route traveled.

### BACKGROUND

A position tracking device is a device that can employ a Global Navigation Satellite System (GNSS), such as the Global Positioning System (GPS), GLONASS or other system such as a wireless carrier network to determine a precise location of a vehicle, person or other asset to which the position tracking device is attached to and/or located in and to record the position of the asset at regular intervals. The recorded location data can be stored within the position tracking device, or recorded location data may be transmitted to a central location database or an internet-connected computer, using a cellular data connection such as the general packet radio service (GPRS) (e.g., a 2G or 3G data network), a 4G Long Term Evolution (LTE) network, Short Message Service (SMS) messages, radio or satellite modem embedded in the position tracking device, etc. This allows the asset's location to be displayed against a map backdrop either in real-time or when analyzing the track later, using tracking software. Position tracking software (e.g., a navigation application) is available for end-user devices, such that an end-user device can execute a navigation application that can operate as a position tracking device (e.g., a smartphone).

A navigation system is a location based navigation system designed to assist in navigation while operating a vehicle (e.g., an automobile or a bicycle). Some navigation systems can be hand-held and can be employed by walkers and/or runners. Moreover, some navigation systems can be integrated with an end-user device, such as a smartphone or a tablet computer. A navigation system can employ a satellite tracking system (e.g., GPS or GLONASS) navigation device to acquire position data to locate a user on a road or trail in a map database stored in or with the navigation system. By employing the map database, the navigation system can provide directions to other locations along roads or trails that are also in the map database. In some examples, the navigation system can implement dead reckoning techniques that employ distance data from sensors attached to a drivetrain of the vehicle, a gyroscope and/or an accelerometer integrated with the navigation system to improve reliability, as satellite signal loss and/or multipath can occur due to obstructions, such as canyons, buildings or tunnels.

### SUMMARY

One example relates to a non-transitory machine readable medium having machine executable instructions comprising a follow-me application. The follow-me application can be configured to generate a follow-me identifier (ID) that uniquely identifies a particular route traveled by a computing device executing the follow-me application. The follow-me application can also be configured to determine route data for the particular route traveled. The route data can characterize turn-by-turn directions to facilitate travel along the particular route by another computing device.

Another example relates to a computing device that can include a location sensor configured to determine location information for the computing device. The location information can characterize a location of the computing device. The computing device can also include a memory configured to store machine readable instructions. The computing device can further include a processing unit configured to access the memory and execute the machine readable instructions. The machine readable instructions can include a follow-me application that can be configured to provide a follow-me identifier (ID) that uniquely identifies a particular route taken by a leader and receive route data characterizing the particular route. The follow-me application can further be configured to output a map that includes a portion of the particular route and a current location of the computing device that is based on the location information.

Yet another example relates to a follow-me server that includes one or more computing devices. The follow-me server can be configured to receive a follow-me ID for a route. The follow-me server can also be configured to determine route data for the route based on location information of a leader. The route data can characterize turn-by-turn directions for travelling along a route taken by the leader.

### BRIEF DESCRIPTION OF THE DRAWINGS

FIG. 1 illustrates an example of a system for facilitating following of a leader.

FIG. 2 illustrates an example of a screenshot that includes a follow-me identifier.

FIG. 3 illustrates an example of a screenshot of a route taken by a leader.

FIG. 4 illustrates an example of a screenshot of a follower following a route traveled by a leader.

FIG. 5 illustrates an example of a screenshot of a follower going off-route from a route traveled by a leader.

FIG. 6 illustrates an example of an end-user device for implementing a follow-me application.

FIG. 7 illustrates an example of a follow-me server.

FIG. 8 illustrates a flowchart of an example of a method for generating route data.

FIG. 9 illustrates a flowchart of an example of a method for following a route taken by a leader.

### DETAILED DESCRIPTION

This disclosure relates to a follow-me application that facilitates travel of a route (or path) by a leader and followers. The leader can traverse (e.g., via driving, walking, biking etc.) the route and route data characterizing turn-by-turn direction for the route (path) can be generated. Followers can identify the route and request the route data. The followers can output a map that includes the route, and receive turn-by-turn navigation instructions for following the route. In this manner, the followers can travel to a destination via the same route (path) that is taken by the leader.

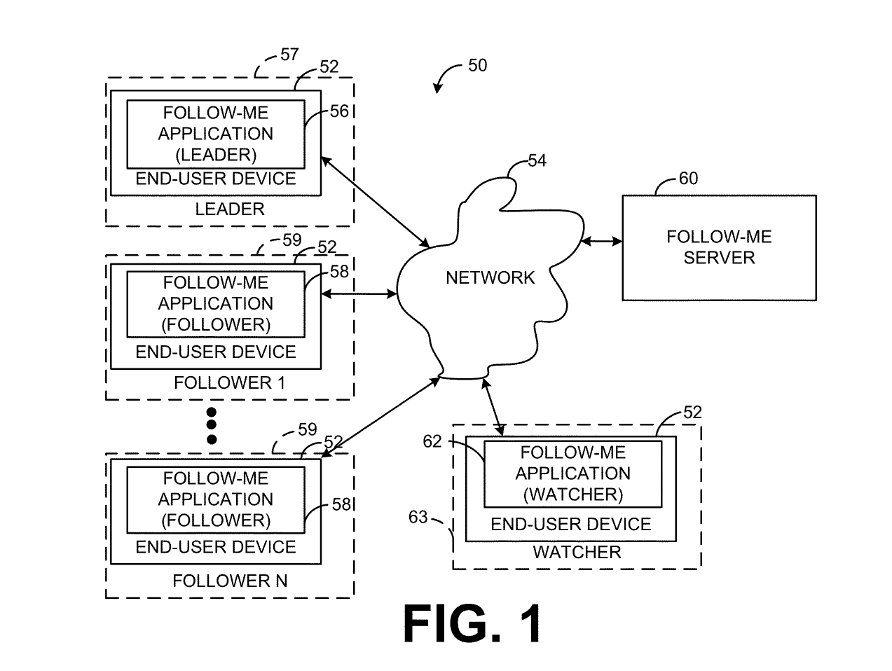

FIG. 1 illustrates an example of a follow-me system 50. The system 50 can include a plurality of end-user devices 52 that communicate over a network 54, such as a data network. The end-user devices 52 can be implemented, for example as mobile devices. For instance, each of the end-user devices 52 can be implemented, as a smartphone, a feature phone, a tablet computer, a laptop computer, a wearable technology device (e.g., a smartwatch), etc. Alternatively, each end-user device 52 can be implemented, as a dedicated consumer device, such as a navigation system. The network 54 could be implemented as a public network (e.g., the Internet), a private network (e.g., a cellular communications network), an ad-hoc network (e.g., a point-to-point network, including a Personal Area Network (“PAN”)) or a combination thereof. Each end-user device 52 can execute an instance of a follow-me application thereon. The follow-me application can be implemented, for example, as application software that is stored in a non-transitory machine readable medium (e.g., memory) of the corresponding end-user device 52.

One of the instances of the follow-me application can be designated (e.g., in response to user input) as a leader application 56 (labeled in FIG. 1 as “FOLLOW-ME APPLICATION (LEADER)”). The end-user device 52 executing the leader application 56 can be referred to as a “leader” 57. A remaining N number of instances of the follow-me application can be designated (e.g., in response to user input) as “Followers Applications” 58 (labeled in FIG. 1 as “FOLLOW-ME APP (FOLLOWER 1)” and “FOLLOW-ME APP (FOLLOWER N)”, where N is an integer greater than or equal to one. Each end-user device 52 executing a follower application 56 can be referred to as a “follower” 59. It is to be understood that the leader application 56 and the N number of follower applications 58 can, in some instances, be the same application operating in different modes, which modes can be referred to as a leader mode and a follower mode. In some examples, communication between the end-user devices 52 can be funneled through a follow-me server 60 (or other system). In other examples, the end-user devices 52 can communicate directly through the network 54 (e.g., direct communication).

The follower applications 58 can allow users of the N number of followers 59 to travel along a route designated by the leader 57. That is, the leader 57 can travel along a route and route data characterizing the route (including turn-by-turn instructions) can be provided to the N number of follower applications 58 in the manner described herein.

As one example, upon instantiation of the follow-me application at each of the end-user devices 52, one of the end-user device 52 can be designated as the leader application 58 in response to user input (e.g., activations of a virtual button in a graphical user interface (GUI)). The leader application 58 can generate a follow-me identifier (ID) for a given route. In some examples, the follow-me ID can be provided to the follow-me server 60. The follow-me ID can be disseminated to the N number of follower applications 58 in a number of different ways. In one example, each of the N number of followers 59 can be “bumped” with the leader 57 such that the follow-me ID is transmitted directly from the leader 57 to each of the N number of follower applications 58 (or some subset thereof) via near field communications (NFC). In other examples, the leader application 58 can be configured to display a Quick Response (QR) code with the follow-me ID embedded therein.

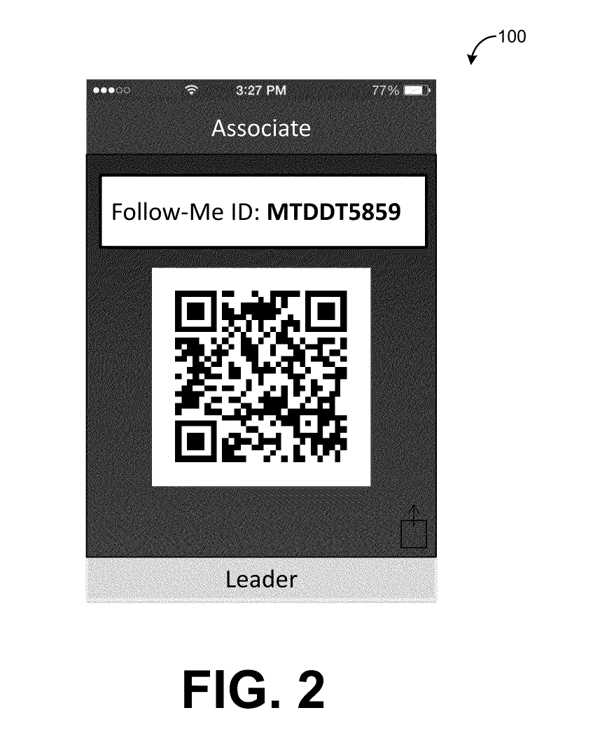

FIG. 2 illustrates an example of a screenshot 100 on the leader 57 displaying the follow-me ID (labeled as “Follow-Me ID”) embedded in a QR code and displayed as an alphanumeric code (labeled in FIG. 2 as “MTDDT5859”). In such a situation, each of the N number of follower applications 58 (or some subset thereof) can scan a display of the leader 57 that is displaying to the QR code. Alternatively, the users of the some or all of the N number of followers 59 can type the follow-me ID manually into the N number of follower applications 58.

Referring back to FIG. 1, in other examples, the follow-me ID can be disseminated to the N number of follower applications 58 upon actuation of a “share” virtual button (or other actuator) at the leader application 56, such as by email, short message service (SMS) message, a Session Initiation Protocol (SIP) message, Extensible Messaging and Presence Protocol (XMPP), verbal or written communication, etc.

Upon dissemination of the follow-me ID, the leader application 56 can monitor the leader's 57 position (e.g., latitude and longitude coordinates) and velocity (speed and heading) based on information derived from satellite signals and/or cellular communication signals via triangulation. The position and velocity can collectively be referred to location information. In some examples, the leader application 56 can provide the follow-me server 60 with the location information for the leader 57. In this situation, the follow-me server 60 can determine turn/route decisions and GPS location by comparing the location information against map data that characterizes street maps of a geographic region that includes the current position of the leader 57. The turn/route decisions can be referred to as route data. In other examples, the leader application 56 can process the location information (including the position and velocity) of the leader 57 to determine the route data locally. In some examples, a given route can be saved (e.g., at the follow-me server 60 and/or the leader 57), such that the given route can be followed by the follower 59 at a point in the future, even if the given route is not being actively traversed by the leader 57.

The route data can be periodically disseminated (e.g., updated) to the follower applications 58. In some examples, the route data can be disseminated using “direct” communication mechanisms (e.g. SMS, ESMS, SIP, XMPP, OTT, email, TCP, etc.). In other examples, the leader application 56 can upload the route data to the follow-me server 60 and the follow-me server 60 can provide the N number of follower applications 58 with the route data.

In some examples, the route data can be captured by employing traditional navigation techniques (e.g., triangulation of satellite signals and/or cellular communication signals) to determine a route. For example, a user of the leader 57 can travel (e.g., drive, walk, bike, etc.) to a destination in situations where the user of the leader 57 knows how to get to the destination. While the leader 57 is on the route, the leader application 56 can capture the turn/route decisions (e.g., maneuvers) that the leader 57 is making (the route data) and share the route data with the follower applications 58 in the form of turn-by-turn directions. A frequency of updates to the route data can be based, for example, on a frequency of detecting turn/route decisions and a velocity of the leader 57. The frequency of the update can be determined empirically, such as by logic, machine learning techniques, etc.

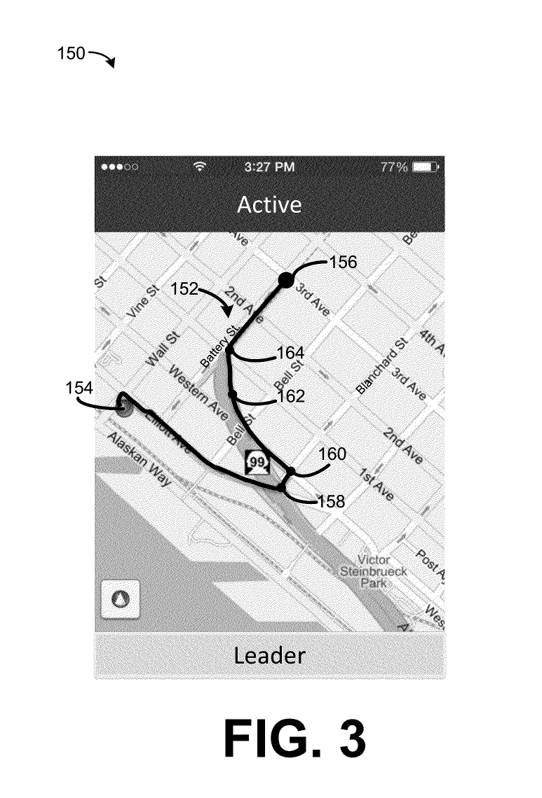

FIG. 3 illustrates an example of a screenshot 150 of the leader 57 depicting a route 152 generated based on route data. The route 152 includes a starting point 154 and an ending point 156. The starting point 154 can correspond to a point at which the follow-me application is designated as the leader application 56 (or some other point). The ending point 156 can correspond to a point at which the follow-me application designated as the leader application 56 ceases/terminates (e.g., in response to user input) monitoring a route of the associated end-user device 52.

In the example illustrated in FIG. 3, different maneuvers (e.g., turn/route decisions) of the leader 57 can result in different turn-by-turn directions for the route 152. For instance, at point 158 on the route 152, the leader 57 makes a left hand turn. In such a situation, the leader 57 (via the leader application 56) and/or the follow-me server 60 of FIG. 1, can determine the route data by detecting a relatively sharp (e.g., about 90°) left hand turn and comparing the continued trajectory of the leader 57 to map data to determine that a left hand turn is made onto “Blanchard St.” A similar left hand turn is made at point 160 and can be detected in a similar manner and added to the route data characterizing the route 152.

Further, at point 162, the leader application 56 and/or the follow-me server 60 of FIG. 1 can determine from the overall trajectory that the leader 57 (e.g., a relatively slow curve) follows Washington State Route 99, such an instruction to merge onto Washington State Route 99 can be added to the route data characterizing the route 152. Still further, at point 164, the trajectory of the leader 57 changes relatively abruptly (e.g., by about 45°) and comparing the trajectory of the leader 57 to the map data (e.g., by the leader application 56 and/or the follow-me server 60 of FIG. 1) can indicate that the leader 57 has made a right hand turn onto “Battery St.”, such that an instruction to turn right on to Battery Street can be added to the route data characterizing the route 152.

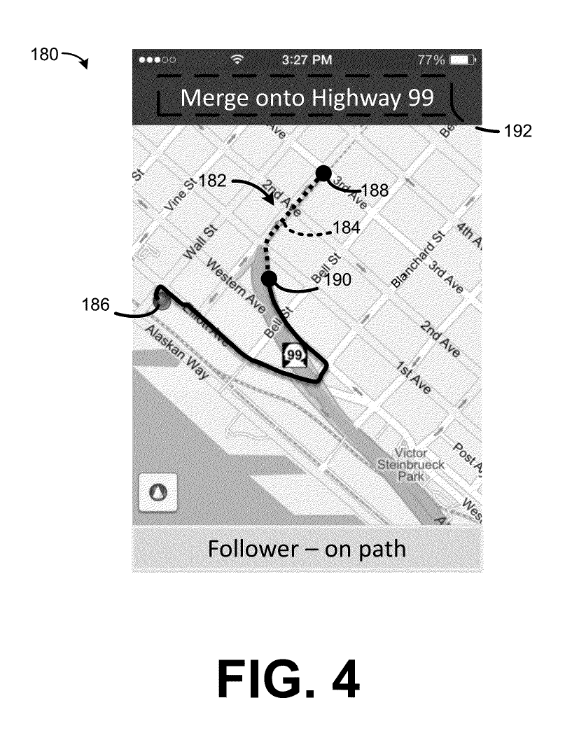

FIG. 4 illustrates an example of a screenshot 180 of a follower 59 of FIG. 1. The screen shot 180 depicts a route 182 taken by the leader 57 (using the leader application 56 of FIG. 1), wherein turn decisions (e.g., turn-by-turn directions) are output to the user of the follower 59 to stay on the route 182 taken by the leader 57. For purposes of simplification of explanation the route 182 depicted in FIG. 4 is the route 152 of FIG. 3 created by the leader 57. In FIG. 4, a portion of the route 182 is depicted with a solid line to denote the portion of the route 182 that has already been traversed by the follower 59. Moreover, in FIG. 4, a portion of the route 182 is depicted with a dotted line to denote the portion of the route 182 that has yet to be traversed by the follower 59.

In FIG. 4, the follower 59 (e.g., via the follower application 58) outputs turn-by-turn instructions (e.g., navigation directions) based on the route data generated for the route 182 from a starting point 186 to an ending point 188. In FIG. 4, it is presumed that the follower 59 is located at position 190. In this situation, a driving (or other mode of travel) instruction 192 (labeled in FIG. 4 as “Merge onto Highway 99”) is output. In this manner the follower 59 can traverse the route 180, which is the same route traversed by the leader 57 (and illustrated in FIG. 3).

Referring back to FIG. 1, while traveling on the route taken by the leader 57 the follower 59 can be referred to as being “on-route”. The follower 59 may deviate from the route taken by the leader 57, which can be referred to as going “off-route”. In such a situation, the follower application 58 can provide the user of the follower 59 with route finding assistance in the form of information (e.g., turn-by-turn driving directions) to “re-sync” to the route taken by the leader 57.

In one example, to provide the route finding assistance, the follower application 58 can employ traditional navigation techniques to get back to the last location (e.g., latitude and longitude defined position) of the follower 59 prior to the follower 59 going off-route, thereby bringing the follower 59 back on-route. In another example, the follower application 58 can employ traditional navigation techniques and compute a new route from the follower's 59 current location to each of the leader's 57 reported locations and automatically select the route that gets the follower 59 back on-route in an efficient manner. In still yet another example, the follower application 58 can employ traditional navigation techniques to direct the user of the follower 59 to a closest or most convenient point on the route from the current position of the follower 59, thereby bringing the follower 59 back on-route at that closest or most convenient position. In these examples, the current location of the leader 57 does not necessarily directly affect the route finding assistance. Instead, the route finding assistance is provided based on the route traveled by the leader 57. This may be use, for example, in situations where the route is traveled by the leader 57 before the follower 59 even begins traveling the route (e.g., in a sight-seeing route).

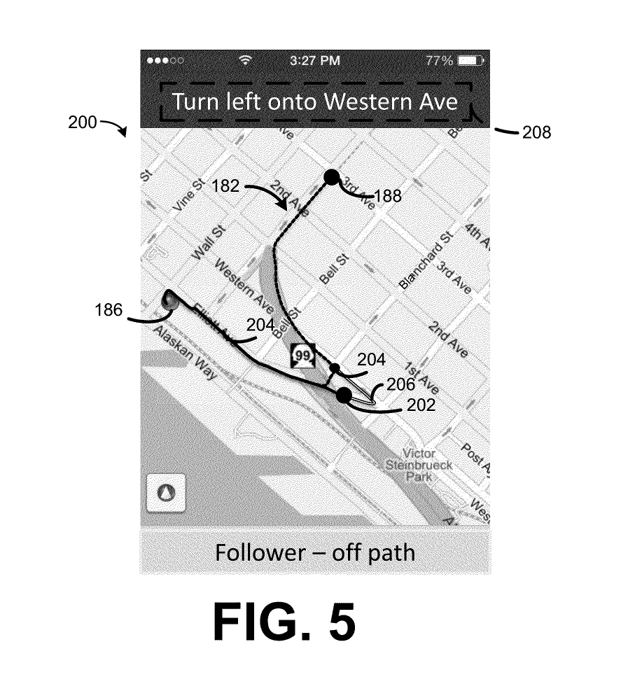

FIG. 5 illustrates an example of a screenshot 200 of a follower 59 following the route 182 wherein the follower 59 has missed a turn and goes off-route. FIGS. 4 and 5 employ the same reference numbers to denote the same structure. In FIG. 5, the follower 59 provides route finding assistance from a current position of the follower 59 at point 202 to a “most convenient” point 204 on the route 182 with a route to get the follower 59 back on-route via a temporary route 206 illustrated in FIG. 5 as double lines. The most convenient point 204 may or may not be the point on the route 206 closest to the current position of the follower 59. Rather, the most convenient point 204 can be the point on the route 182 that has the least number of turns and/or the shortest expected travel time for bringing the follower 59 back on-route from a current position. The route finding assistance can be in the form of turn-by-turn directions 208 (labeled in FIG. 5 as “Turn left onto Western Ave”).

In some examples, other features may additionally or alternatively be included. For instance, in some instances, the follower applications 58 can periodically provide a current location (e.g., latitude and longitude coordinates) to the other end-user devices 52, including the leader 57 and other followers 59. In response, the leader application 56 and/or the other follower applications 58 can display a current position of each (or some subset) of the N number of followers 59. Additionally or alternatively, the leader application 56 and/or the other follower applications 58 can employ the current location of the follower 59 to provide an alert when/if the follower 59 goes off-route.

Referring back to FIG. 1, in some examples, another non-participating end-user device 52 can execute an instance of the follow-me application that operates in a non-participating watcher (or lurker) mode, which can be referred to as a watcher application (labeled in FIG. 1 as “FOLLOW-ME APPLICATION (WATCHER)”). The end-user device 52 executing the watcher application 62 can be referred to as a watcher 63. The watcher application 62 can display the current position of the leader 57 and/or the followers 59 (or some subset thereof).

In some examples, upon the leader 57 and the N number of followers 59 arriving at a destination, a group can be formed. The follow-me application (e.g., either the leader application 56 and/or one or more of the follower applications 58) can, in some examples, share the destination and/or the identity of the group with others. For instance, the destination and/or the identity of the group could be posted on a social networking application. In a similar manner, the follow-me application (e.g., either the leader application 56 and/or the follower applications 58) can post information about the group on the social network while the group is on-route to the destination.

By employing the system 50, users of the leader 57 and/or the followers 59 can easily ensure that the users are in relatively close proximity while traveling to a destination. This can be useful, for example, in situations where the destination is unknown. Such an unknown destination can include, but is not limited to a retail establishment (e.g., a restaurant) with an acceptable wait time, a location with a favorable view (e.g., in a park), etc. Moreover, in some situations, the system 50 could be used when traditional navigation techniques are unavailable. For instance, the system 50 could be employed on a walking trail, an off-road path, through a closed campus or other areas that do not have streets available as general street layers for navigation. In these situations, landmarks or distances can be determined by the leader application 56 and/or the follow-me server 60 and disseminated to the follower applications 58 as a portion of the route data.

Additionally, in other examples, the route to a known destination can be taken by the leader 57 (and followed to by the N number of followers 59) to avoid traffic and/or construction. Yet further, as noted, route data for a particular route can be determined by the leader 57 and/or the follow-me server 60 and the route data can be stored the particular route at the follow-me server 60, and the followers 59 can request and receive the route data for the particular route at the N number of follower applications 58. In such a situation, the N number of followers 59 can traverse the particular route well after the leader 57 has terminated the generation of the particular route. This can be used, for example, to set up and follow particular viewing routes (e.g., historical monument routes, routes for viewing holiday lights, etc.).

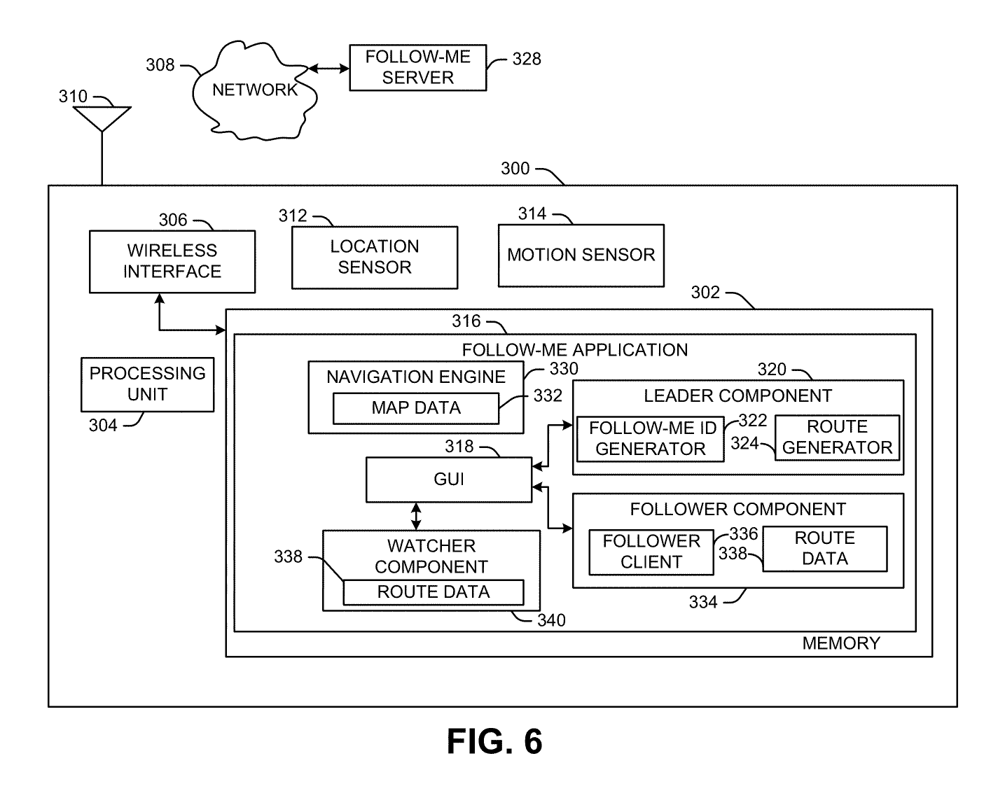

FIG. 6 illustrates an example of an end-user device 300 that can provide assistance in leading or following other users (and other end-user devices). The end-user device 300 could be employed, for example, as a given end-user device 52 of the N number of end-user devices 52 of FIG. 1. The end-user device 300 could be implemented, for example, as a mobile device, such as a smart phone, a feature phone, a wearable technology device (e.g., a smartwatch), a tablet computer, a laptop computer, etc. In some examples, the end-user device 300 could be implemented in an in-dash vehicle navigation system. The end-user device 300 can include a memory 302 to store data and machine readable instructions. The memory 302 can be implemented, for example, as a non-transitory machine readable medium. In some examples, the memory 302 can include volatile memory (e.g., random access memory) and/or nonvolatile memory, such as flash memory, a solid state drive a hard disk drive or a combination thereof. The end-user device 300 can also include a processing unit 304 configured to access the memory 302 and execute the machine readable instructions. The processing unit 304 can include one or more processor cores.

The end-user device 300 can include a wireless interface 306 that can communicate with a network 308 via an antenna 310. The wireless interface 306 can communicate via a standard wireless communication protocol, such as a protocol of a carrier network, Wi-Fi, Bluetooth, Infrared, continuous wave (e.g., Morse code), etc. The network 308 could be representative of a carrier network, such as a Long Term Evolution (LTE) network, a 4th Generation (4G) network, a 3rd Generation Partnership Project (3GPP) network, a 3rd Generation (3G) network, etc. Additionally or alternatively, the network 308 can be representative of a public network, such as the Internet.

The end-user device 300 can further include a location sensor 312. The location sensor 312 can be configured to determine location information for the end-user device 300. The location information can be implemented as longitude and latitude coordinates of the end-user device 300. In some examples, the location information can be based on received RF signals that are transmitted from satellites (e.g., GNSS satellites). In other examples, the location information can be based on a triangulation of RF signals received from cell towers at the antenna 310. In some examples, the RF signals can also be employed to calculate a velocity (speed and heading) of the end-user device 300, and the velocity can be included in the location information.

Additionally or alternatively, the end-user device 300 can include a motion sensor 314, such as an accelerometer. The motion sensor 314 can provide motion data (e.g., acceleration data) that can be employed to calculate a velocity vector (speed and heading) of the end-user device 300. In some examples, the motion data can augment the location information, and in other examples, the motion data can be kept separate from the location information.

The memory 302 can include a follow-me application 316 that can include a GUI 318 that can provide the user of the end-user device 300 with an option to execute the follow-me application in a leader mode, a follower mode or a watcher mode.

The follow-me application 316 can include a leader component 320 that can be configured to execute in response to the user of the follow-me application 316 selecting the leader mode. The leader component 320 can cause the follow-me application 316 to operate as a leader application (e.g., the leader application 56 of FIG. 1). The leader component 320 can include a follow-me ID generator 322 that can be configured to generate a unique follow-me ID for a given route in response to selection of the leader mode at the GUI 318. The follow-me ID can be, for example an alphanumeric code that can be disseminated to an end-user device with a follow-me application executing in follower mode, which can be referred to as a follower. In some examples, to disseminate the follow-me ID to the follower, the follow-me ID can be provided to the GUI 318, and the GUI 318 can output the follow-me ID.

The follow-me ID can be output as a string, a barcode (e.g., a one dimensional barcode, a matrix barcode, such as a QR code, etc.), etc. The follow-me ID can be output in a manner similar that the screenshot 100 illustrated and described with respect to FIG. 2. In other examples, the follow-me ID can be provided to a follow-me server 328 via the network 308 that can be implemented in a manner similar to the follow-me server 60 illustrated in FIG. 1. As explained herein, in such a situation, the follower application can receive the follow-me ID from the follow-me server 328. In still other examples, the follow-me ID can be provided to the follower via direct communication (e.g., point-to-point communication, including NFC). For instance, the follow-me ID can be disseminated to the follower upon actuation of a “share” virtual button (or other actuator) output on the GUI 318, such as by email, SMS message, a SIP message, XMPP, verbal or written communication, etc.

The leader component 320 can also include a route generator 324 that can be configured to monitor the location information of the end-user device 300 including the position (e.g., latitude and longitude coordinates) and velocity (speed and heading) based on data provided from the location sensor 312 and the motion data provided from the motion sensor 314. In some examples, the route generator 324 can provide the follow-me server 328 with the location information characterizing the position and velocity of the end-user device 300. In this situation, the follow-me server 328 can determine turn/route decisions and a geographic location for the end-user device 300 by comparing the location information (e.g. position and velocity) against map data that characterizes street maps and/or other geographic features (e.g., topography). The turn/route decisions can be referred to as route data. In other examples, the follow-me application 316 can include a navigation engine 330 and map data 332. In such a situation, the route generator 324 and/or the navigation engine 330 can process the position and velocity of the end-user device 300 to determine the route data locally. In some examples, a given route can be saved and provided to the follow-me server 328, such that the given route can be followed by the follower at a point in the future, even if the given route is not being actively traversed by the end-user device 300.

The route data can be periodically or asynchronously disseminated (e.g., updated) to the follower. In some examples, the route data can be disseminated using “direct” communication mechanisms (e.g. SMS, ESMS, SIP, XMPP, OTT, email, TCP, etc.). In other examples, the leader component 320 can send the route data and/or the location information to the follow-me server 328 and the follow-me server 328 can provide the follower applications 68 with the route data.

In some examples, the route data can be captured by employing traditional navigation techniques (e.g., triangulation of satellite signals and/or cellular communication signals) to determine a route traveled. For instance, a user of the end-user device 300 can travel (e.g., drive, bike or walk) to a destination in situations where the user of the end-user device 300 knows how to get to the destination. While the end-user device 300 is on the route, the route generator 324 and/or the follow-me server 328 can capture the turn/route decisions the leader is making (included in the route data) and share the route data with the follower. The route generator 324 can determine a frequency of updates to the route data and/or location information that is relative to turn/route decisions. The frequency of the updates could be determined empirically, such as by logic, machine learning techniques, etc. The screenshot 150 illustrated and described with respect to FIG. 3 includes a route 152 that could be characterized in the route data.

Additionally, the follow-me application 316 can include a follower component 334 that can be executed in response to the user of the end-user device selecting the follower mode. Selection of the follower mode can cause the follow-me application 316 to operate as a follower application (e.g., one of the N number of follower applications 58 of FIG. 1).

The follower component 334 can include a follower client 336. The follower client 336 can be configured to interface with a leader application (e.g., a leader component, such as a component similar to the leader component 320). The follower client 336 can be configured to receive a follow-me ID from the GUI 318, the network 308 or via an imaging (e.g., barcode scanning) process. The follow-me ID can be implemented in a manner similar to the follow-me ID generated by the follow-me ID generator 322 of the leader component 320.

Upon receiving the follow-me ID, in some examples, the follower client 336 can provide a request (e.g., a subscription request) for route data 338 for the route corresponding to the follow-me ID. The request for the route data 338 can, in some examples, be provided to the follow-me server 328. In other examples, the request for the route data 338 can be provided to another end-user device that has the follow-me application executing in the leader mode, which can be referred to as a leader. In either situation, the route data 338 can be received by the follower client 336 in response to the request.

The follower client 336 can process the route data 338 and, in some examples, the flower client 336 can employ the navigation engine 330 to determine turn-by-turn directions for the end-user device 300 such that the end-user device 300 can follow a route defined by the route data 338. For instance, the navigation engine 330 can employ traditional navigation techniques to compare a current position of the end-user device 300 against a location on a map characterized in the map data 332. In other examples, the route data 338 can include the turn-by-turn directions. A map can be output at the GUI 318 that includes a current position of the end-user device 300, a current position of the leader and the route being followed by the end-user device 300. The screen shot 180 illustrated and described with respect to FIG. 4 includes an example of a map that could be output at the GUI 318 while the follow-me application 316 is operating in follower mode (e.g., as a follower application). The follower client 336 can continuously or intermittently monitor the location information (e.g., the position and velocity) of the end-user device 300. Moreover, in some examples, the follower client 336 can receive location information (e.g., a position and velocity) of other end-user devices (e.g., “other followers”) executing a follower application and following the leader. In such a situation, the position of the other followers can be output on the map displayed by the GUI 318.

While traveling on the route defined in the route data 338, the follower client 336 can employ the location information of the end-user device 300 and the route data 338 to determine if the end-user device is “on-route”. In some situations, the user of the end-user device 300 may intentionally or unintentionally deviate from the route traveled by the leader application, thereby causing the end-user device 300 to go “off-route”. In such a situation, the follower client 336 can provide route finding assistance via the GUI 318 to re-synch the end-user device 300 with the route identified in the route data 338.

In one example, to provide the route finding assistance, the navigation engine 330 can employ traditional navigation techniques (e.g., turn-by-turn directions) to get back to the last location (e.g., latitude and longitude defined position) of the end-user device 300 prior to the end-user device going off-route, thereby bringing the follower back on-route. In another example, the navigation engine 330 can employ traditional navigation techniques and compute a new route from the current position of the end-user device to the a closest and/or most convenient point on the route from the current position of the follower, thereby bringing the follower back on-route at that closest or most convenient position. In these examples, the current position of the leader may not directly affect the route finding assistance. Instead, the route finding assistance is provided at the GUI 318 based on the route traveled by the leader. This may be used, for example, in situations where the route defined in the route data 338 is traveled by the leader prior to the end-user device 300 initiating traveling on the route (e.g., in a sight-seeing route).

The follow-me application 316 can further include a watcher component 340. Selection of the watcher mode can cause the follow-me application 316 to operate as a watcher application. The watcher component 340 can include features similar to the follower component 334. In particular, the watcher component 340 can receive route data 338 in a manner similar to the follower component 334. However, in contrast to the follower component 334, during operation of the watcher mode, the watcher component 340 does not need to monitor the current position of the end-user device 300 relative to the route identified in the route data 338. Instead, the watcher component 340 can output a current position of the leader at the GUI 318 overlaying a map and a route defined in the route data 338. Additionally, in some examples, the watcher component 340 can output a current position of a follower (or multiple followers) on the map output by the GUI 318.

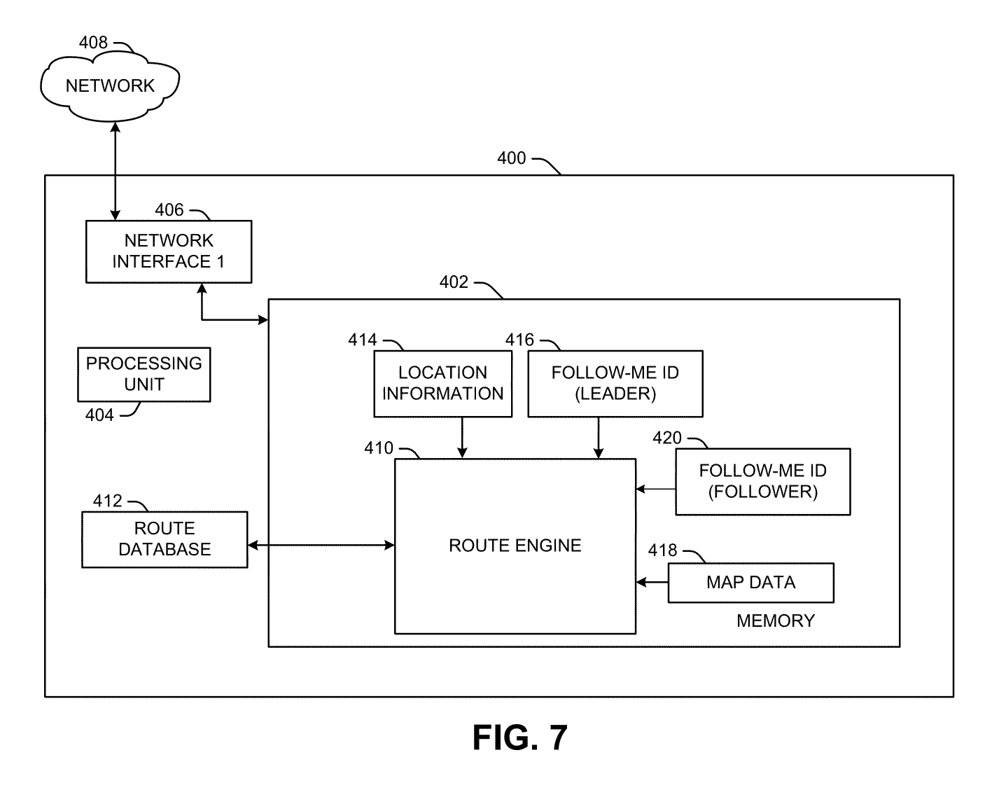

FIG. 7 illustrates an example of a follow-me server 400 that could be employed, for example, as the follow-me server 60 illustrated in FIG. 1. The follow-me server 400 can include a memory 402 that can store machine readable instructions. The memory 402 could be implemented, for example, as non-transitory computer readable media, such as volatile memory (e.g., random access memory), nonvolatile memory (e.g., a hard disk drive, a solid state drive, flash memory, etc.) or a combination thereof. The navigation server 400 can also include a processing unit 404 to access the memory 402 and execute the machine-readable instructions. The processing unit 404 can include, for example, one or more processor cores. The navigation server 400 can include a network interface 406 configured to communicate with a network 408. The network interface 406 could be implemented, for example, as a network interface card. The network 408 could be implemented for example, as a public network (e.g., the Internet), a private network (e.g., a carrier network) or a combination thereof.

The follow-me server 400 could be implemented, for example in a computing cloud. In such a situation, features of the navigation server 400, such as the processing unit 404, the network interface 406, and the memory 402 could be representative of a single instance of hardware or multiple instances of hardware with applications executing across the multiple of instances (distributed) of hardware (e.g., computers, routers, memory, processors, or a combination thereof). Alternatively, the follow-me server 400 could be implemented on a single dedicated server.

The memory 402 can include a route engine 410 that can be configured to determine a route for a leader application executing on an end-user device, which can be referred to as a leader. The route engine 410 can be configured to receive a follow-me ID 416 from the leader via the network 408. The follow-me ID 416 can be implemented as an alphanumeric code that can uniquely identify a route, as described herein. The follow-me ID 416 can be stored in a record of a route database 412. The route database 412 can be implemented, for example, as a non-transitory machine readable medium (e.g., volatile or nonvolatile memory). In some examples, the route database 412 could be implemented as a different type of data structure such as a table, a list, etc.

Additionally, the route engine 410 can receive location information 414 from the leader via the network 408 that includes a current position and velocity (e.g., speed and heading) of the leader. The location information 414 from the leader can be processed in a manner described herein to derive turn-by-turn directions for a route associated with the follow-me ID 416 to determine route data. For instance, as explained with respect to FIG. 3, the location information 414 can be compared against map data 418 that characterizes a map of a geographic area to identify specific maneuvers of the leader (e.g., turns at intersections, merging on to particular roads, etc.). The determined route data can be stored in the route database 412 in a record that can be indexed by the follow-me ID 416 provided by the leader.

In some examples, while the leader is “on-route” toward a (known or unknown) destination, a follower (e.g., an end-user device executing a follower application) and/or a watcher (e.g., an end-user device executing a watcher application) can provide a follow-me ID 420 and a request for route data via the network 408. In other examples, the leader may provide an indication that the destination has been reached prior to receipt of the follow-me ID 420 and the request for route data from the follower and/or watcher.

In either situation, the route engine 410 can be configured to access the route database 412 and retrieve the route data associated with the follow-me ID 420 provided from the follower and/or watcher. As noted, in some situations, the route data may be updated while the leader is on-route to the destination. In this situation, the route data can be updated to the follower in near real time. In situations where the leader indicates that the route has been terminated prior to receipt of the follow-me ID from the follower, the route data can be provided to the follower in a complete form.

In some examples, the follower can provide the location information (e.g., position and velocity) for itself to the route engine 410. In some such situations, the route engine 410 can forward the location information for the follower to the leader, such that the leader can actively track a position of the follower in a manner described herein. Additionally, in some examples, in response to the request for route data, the route engine 410 can provide information characterizing a position of the leader and/or other followers to the follower and/or the watcher. In this manner, the follower and/or the watcher can actively track the location of the leader and other followers on a map in near real-time.

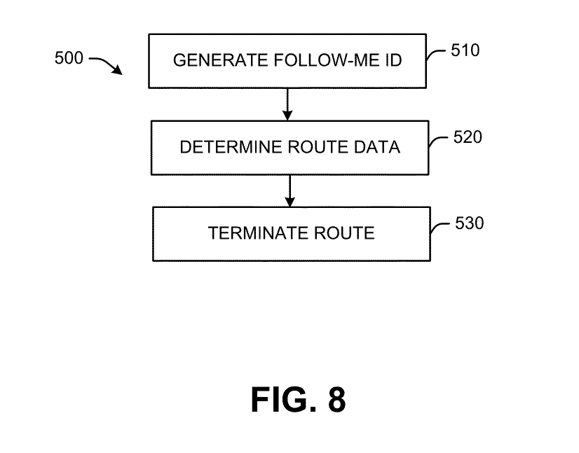

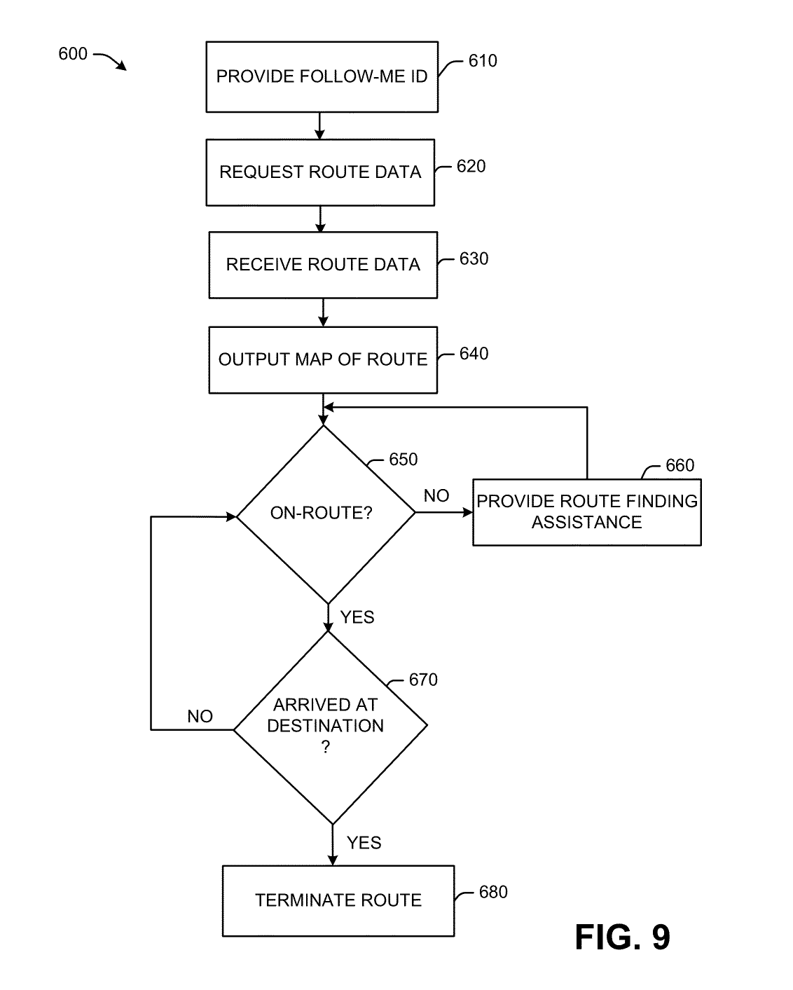

In view of the foregoing structural and functional features described above, example methods will be better appreciated with reference to FIGS. 8 and 9. While, for purposes of simplicity of explanation, the example methods of FIGS. 8 and 9 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method. The example methods of FIGS. 8 and 9 can be implemented as instructions stored in a non-transitory machine-readable medium. The instructions can be accessed by a processing resource (e.g., one or more processor cores) and executed to perform the methods disclosed herein.

FIG. 8 illustrates an example flowchart of a method 500 for generating route data for a route followed by a follower. The method 500 can be implemented, for example, by an end-user device executing a follow-me application in leader mode, which can be referred to as a leader (e.g., the leader 57 of FIG. 1) and/or a follow-me server (e.g., the follow-me server 60 of FIG. 1). At 510, a follow-me ID can be generated by the leader. The follow-me ID can uniquely identify the route.

At 520, the route data can be determined based on a continued monitoring of location information (e.g., position and velocity) of the leader. The route data can be determined by the leader and/or the follow-me server. The route data can characterize turn-by-turn directions (e.g., driving or walking directions) for the route. At 530, the route can be terminated, which can indicate that the leader has arrived at a known or unknown destination.

FIG. 9 illustrates an example of a method 600 for following a route generated by a leader. The method 600 can be implemented, for example, by a follower (e.g., an end-user device executing a follow-me application in follower mode), such as the follower 59 of FIG. 1. At 610, the follower can provide a follow-me ID that is generated by a leader. At 620, a request (e.g., a subscription request) for the route data corresponding to the route identified by the follow-me ID can be requested by the follower. The request can be provided, for example, to a follow-me server (e.g., the follow-me server 60 of FIG. 1) and/or the leader.

At 630, the route data can be received at the follower. It is noted that in some examples, the route data can be updated intermittently (or continuously) in situations where the leader has not terminated the route prior to the follower providing the follow-me ID. The route data can characterize turn-by-turn directions for travel along a route taken by the leader.

At 640, a map of the route taken by the leader can be output to a user of the follower. At 650, a determination by the follower can be made as to whether the follower is “on-route” relative to the route characterized in the route data. If the determination at 650 is negative (e.g., NO), the method 600 can proceed to 660. If the determination at 650 is positive (e.g., YES), the method 600 can proceed to 670. At 660, route finding assistance can be provided to the follower. The route finding assistance can assist the user of the follower in re-synching to the route characterized in the route data, and the method can return to 650.

At 670, a determination can be made by the follower as to whether the follower has arrived at the destination. If the determination at 670 is positive (e.g., YES), the method 600 can proceed to 680. If the determination at 670 is negative (e.g., NO), the method 600 can return to 650. At 680, the route can be terminated by the follower, such as in response to user input and/or reaching a destination in the route characterized in the route data.

In view of the foregoing structural and functional description, those skilled in the art will appreciate that portions of the systems and method disclosed herein may be embodied as a method, data processing system, or computer program product such as a non-transitory computer readable medium. Accordingly, these portions of the approach disclosed herein may take the form of an entirely hardware embodiment, an entirely software embodiment (e.g., in a non-transitory machine readable medium), or an embodiment combining software and hardware. Furthermore, portions of the systems and method disclosed herein may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processors of a general purpose computer, special purpose computer, or other programmable data processing apparatus (or a combination of devices and circuits) to produce a machine, such that the instructions, which execute via the one or more processors, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”), a wide area network (“WAN”), e.g., the Internet and a PAN, such as a Bluetooth network, an Infrared network, a continuous wave (e.g., Morse Code) network, etc.

The computing system can include clients and servers. A client and server are generally remote from each other and typically interact through a communication network. The relationship of client and server arises by virtue of computer programs running on the respective computers and having a client-server relationship to each other.

What have been described above are examples. It is, of course, not possible to describe every conceivable combination of structures, components, or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A non-transitory machine readable medium having machine executable instructions comprising a follow-me application, the follow-me application being configured to:
generate a follow-me identifier (ID) that uniquely identifies a particular route traveled by a computing device executing the follow-me application; and
determine route data for the particular route traveled, wherein the route data characterizes turn-by-turn directions to facilitate travel along the particular route by another computing device.

2. The medium of claim 1, wherein the turn-by-turn directions correspond to maneuvers taken by the computing device along the route.

3. The medium of claim 2, wherein the turn-by-turn direction characterizes at least one of street names and landmarks.

4. The medium of claim 1, wherein the determining is based on a monitored position and a velocity of the computing device relative to map data that characterizes a geographic map.

5. The medium of claim 1, wherein the follow-me application is further configured to output a barcode that encodes the follow-me ID.

6. The medium of claim 1, wherein the follow-me application is further configured to update the route data in near real-time as the computing device travels to a destination.

7. The medium of claim 6, wherein a frequency for updating the route data is based on a frequency of detecting turn/route decisions and a velocity of the computing device.

8. The medium of claim 6, wherein the follow-me application is further configured to:
receive location information of the other computing device that is traversing the particular route; and
output a map that includes a near real-time position of the computing device and the other computing device.

9. The medium of claim 1, wherein the route data is stored at a follow-me server.

10. A computing device comprising:
a location sensor configured to determine location information for the computing device, the location information characterizing a location of the computing device;
a memory configured to store machine readable instructions; and
a processing unit configured to access the memory and execute the machine readable instructions, the machine readable instructions comprising a follow-me application being configured to:
provide a follow-me identifier (ID) that uniquely identifies a particular route taken by a leader;
receive route data characterizing the particular route; and
output a map that includes a portion of the particular route and a current location of the computing device that is based on the location information.

11. The computing device of claim 10, wherein the follow-me application is further configured to:
monitor the location of the computing device relative to the particular route; and
provide route finding assistance in response to determining that the computing device has deviated from the particular route.

12. The computing device of claim 11, wherein the route finding assistance characterizes instructions for returning to a point at which the computing device deviated from the particular route.

13. The computing device of claim 11, wherein the route finding assistance characterizes instructions for traveling to a point on the particular route that is nearest to the location of the computing device.

14. The computing device of claim 11, wherein the route finding assistance characterizes instructions for traveling to a point on the particular route that is determined to have at least one of the shortest expected traveling time and the least number of turns from a current location of the computing device.

15. The computing device of claim 10, wherein the follow-me application is further configured to receive an update to the route data.

16. The computing device of claim 10, wherein the follow-me application is further configured to output a location of the leader.

17. A follow-me server comprising one or more computing devices, the follow-me server being configured to:
receive a follow-me identifier (ID) for a route; and
determine route data for the route based on location information of a leader, wherein the route data characterizes turn-by-turn directions for travelling along a route taken by the leader.

18. The follow-me server of claim 17, wherein the determination is based on a comparison of the location information relative to map data.

19. The follow-me server of claim 17, wherein the turn-by-turn directions characterize street names.

20. The follow-me server of claim 17, wherein the follow-me server is further configured to store the route data for the route in a route database, wherein the route data is indexed by the follow-me ID.
